(19) United States
(12) Patent Application Publication
(10) Pub. No.: US 2025/0351797 A1
(43) Pub. Date: Nov. 20, 2025

(54) Reduced Bulk Density Animal Litter

(71) Applicant: Josh Wiesenfeld, Santa Monica, CA (US)

(72) Inventor: Josh Wiesenfeld, Santa Monica, CA (US)

(73) Assignee: Boxiecat LLC, Santa Monica, CA (US)

(21) Appl. No.: 19/207,667

(22) Filed: May 14, 2025

Related U.S. Application Data
(60) Provisional application No. 63/648,410, filed on May 16, 2024.

(51) Int. Cl. A01K 1/015; B01J 20/12; B01J 20/24; B01J 20/28

(52) U.S. Cl. CPC A01K 1/0155; A01K 1/0154; B01J 20/12; B01J 20/24; B01J 20/28011; B01J 20/28016

(57) ABSTRACT

An animal litter product comprising sodium bentonite granules and particulated compressed cellulose sponge, wherein the compressed cellulose sponge is not treated with any clumping agents, gelling agents or wetting agents; wherein the compressed cellulose sponge is not agglomerated with other components; and wherein the compressed cellulose sponge particles are present in the litter from about 1 to 10 wt. %, and the sodium bentonite granules are present from about 99 to 90 wt. %.

### CROSS-REFERENCE TO RELATED APPLICATIONS

This application claims the benefit of provisional patent application 63/648,410, filed May 16, 2024, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present invention relates to animal litter, and more particularly to animal litter that has reduced bulk density compared to granulated sodium bentonite clay. The animal litter also provides improved aqueous absorptivity.

### Related Art

Prior art animal litter, pet litter and cat litter are well-known in the art. The properties of desirable animal litter are absorbency, clumping and reduced bulk density.

Because clays are heavy, it is desirable to reduce the weight to reduce shipping costs, reduce the amount of material needed to fill the same relative volume of the litter box, and to make the material easier for customers to carry. Exemplary light-weighting materials include but are not limited to perlite, expanded perlite, volcanic glassy materials having high porosities and low densities, vermiculite, expanded vermiculite, pumice, silica gels, opaline silica, tuff, foams and lightweight agricultural byproducts. When selecting a light-weighting material, the effect the light-weighting material will have on the litter's performance is an important consideration. Factors to evaluate include how the light-weighing material will effect cost, ease of manufacture, clumping, tracking, absorbency, odor control, sticking to the box, dust, etc. In some cases, the lightweight materials may be performance-enhancing. In most applications, the light weight is combined with a clay, such as granulated sodium bentonite.

The above-listed lightweight materials may or may not be absorbent, but none of them, in their raw, unaltered state, provide all the desired properties of reduced bulk density, absorbance and clumping in one unaltered material. Another issue when using lightweight materials in combination with granulated clay is particle segregation, where the less dense material segregates from more dense clay. The preferred light weight material does not segregate.

U.S. Pat. No. 7,603,964 discloses a reduced bulk density pet litter made of an agglomerated mixture of (1) a plurality of particles of at least one absorbent clay material and (2) a plurality of particles of at least one light-weighting material, said agglomerated mixture suitable for use as an animal litter; and optionally a plurality of particles of at least one performance-enhancing active incorporated into said agglomerated mixture.

U.S. 2008/0318,762 discloses an agglomeration method for forming reduced bulk density composites suitable for use as an animal litter comprising the steps of: (a) providing particles of bentonite clay with a particle size ranging from 150 μm-5 mm; (b) at least one performance-enhancing active; (c) providing moisture; (d) agglomerating the particles to form bonds between the individual particles of bentonite and performance-enhancing active, the bonds having moisture present in the interstitial spaces thereof, and (e) introducing a gas during the agglomeration step to form composites having reduced bulk density and increased particle strength.

U.S. Pat. No. 9,894,877 discloses that swelling clay made of sodium bentonite has been used to promote clumping in cat litter products but has the disadvantage of being relatively expensive. According to a broad aspect, the invention provides a composition comprising: a mixture comprising sodium bentonite and one or more granular filler materials, wherein the one or more granular filler materials comprise one or more cellulose-containing materials, wherein sodium bentonite comprises at least 47% of the total external surface area of the mixture, wherein the one or more granular filler materials comprise 5% to 53% of the total external surface area of the mixture, and wherein the mixture is removably clumpable. The term “filler” and the term “filler material” refer to a material in a litter product other than a clumping agent, i.e., other than sodium bentonite or a clumping additive. In one embodiment of the present invention, a filler material may be calcium bentonite. In one embodiment of the present invention, the filler material may be a cellulose-containing material.

U.S. Pat. No. 3,765,371 discloses the use of foamed rubber particles in cat litter. However, the density of the foam particles is not disclosed. The use of a wetting agent on the foam is presented in many of the examples. However, it is an important consideration, in that low density foam fails to provide a desirable cat litter. Low density foam makes an uncomfortable litter for cats, whose paws sink through it to the bottom of the litter box. Additionally, when cats scratch to cover their feces, the low density foam flies out of the box.

### SUMMARY OF THE INVENTION

The present invention is an animal litter product comprising a combination of granulated sodium bentonite and particulated compressed cellulose sponge. The particulated compressed cellulose sponge is absorbent and has a low density, in the range of from about 0.5 to 0.1 g/cc. The compressed cellulose sponge is not treated with any clumping agents, gelling agents or wetting agents. The compressed cellulose sponge is not agglomerated with other components. In a preferred embodiment, the compressed cellulose sponge particles are present from about 1 to 10 wt. %, and the granulated sodium bentonite is present from about 99 to 90 wt. %. To prevent particle segregation, where the particles separate after mixing or upon storage, compressed cellulose sponge must be cut in an approximate cubic shape with a length by width by depth dimension of from 10 mm³ to 0.1 mm³. The sodium bentonite clay is granulated and is preferably in the range of from 10 to 15 screen mesh. More preferably, it is about 12 screen mesh (1.6 mm).

Another way of measuring the amount particulated compressed cellulose sponge to granulated sodium bentonite is by a volume ratio. The preferred volume ratio of particulated compressed cellulose sponge to of granulated sodium bentonite is in the range of from 50:50 v/v to 10:90 v/v. A more preferred volume ratio of particulated compressed cellulose sponge to of granulated sodium bentonite is in the range of from 40:60 v/v to 20:80 v/v.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

Granulated sodium bentonite is dry blended with particulate compressed cellulose sponge to form animal litter. Sodium bentonite comprises at least one water-swellable clay mineral in the montmorillonite clay family. These materials have the ability to clump and harden after contact with an aqueous liquid such as urine. This facilitates the removal of only the soiled portion of the litter in a litter box or cage during cleaning without the necessity of removing all the litter. Granulated sodium bentonite is heavy, having a bulk density of approximately 1.1 g/cm³.

Compressed sponges are also known as expanding, swelling or pop-up sponges. They are formed using dry cellulose sponges which are compressed under high pressure and heat. On contact with liquids they expand to their original (non-compressed) size and have the same properties as un-pressed sponge from thereon. The liquid absorption factor of a compressed sponge is up to 20 times its own weight. Different compressed cellulose sponges have different expansion ratios. A ratio of 10:1 indicates that the wetted compressed cellulose sponge will expand 10 times its compressed size. A preferred ratio range is from 10:1 to 5:1, which enhances the clumping effect. The compressed cellulose sponges are commercially available as sheets that have a smooth intact surface. The thickness varies, and the preferred thickness for the present invention is about 1 mm. The compressed cellulose sponge of the present invention is not treated with any clumping agents, gelling agents or wetting agents. Before used as animal litter, the compressed cellulose sponge is not agglomerated with other components. The particulate compressed sponge of the present invention is untreated with chemicals to increase absorptivity and clumping.

Dry cellulose sponge that is used to make the compressed cellulose sponge is made from hemp fibers, sodium sulphate crystals, and wood pulp (cellulose). Flax and other ingredients are added to certain formulations for durability, chemical resistance, or other benefits. In huge water containers, sheets of cellulose are combined with softeners to create a jelly-like slurry that is later mixed with sodium sulfate crystals. After mixing, the material is poured into a mold. The cellulose mixture is heated in this mold. Sodium sulfate crystals melt and drain through holes at the bottom of the mold while it cooks. As a result of the melting, the sponge has distinctive pores. The cellulose mixture is heated and turns into a rigid porous block. The block is then bleached and washed.

The process to make cellulose sponges are well known in the art and is disclosed in U.S. Pat. Nos. 2,853,395 and 3,131,076, which are hereby incorporated by reference.

### Examples of the Invention

### Creating Compressed Cellulose Sponge (CCS) Particles

The sheets of 1 mm thick compressed cellulose sponge were fed through a P7 cross cut shredder to make about 1 mm³ cubes, or particles.

### Test 1—the Particulated CCS was Tested for Water Absorptivity as Follows:

The absorption test is made by placing 10 g of test material on a fine mesh 2.375″ oval tea strainer, which is then immersed in distilled water for 1 second, removed and allowed to drain for five seconds then weighed.

### Test Results:

Granulated sodium bentonite alone gained water weight of 87.5% of the initial weight. A combination of 95 wt. % granulated sodium bentonite and 5 wt. % CCS gained water weight of 227.2% of the initial weight. The wt. % absorptivity of the sodium bentonite with the 5 wt. % CCS increased more than 2.5 times that of sodium bentonite alone. The preferred animal litter will have an increased absorptivity of at least 200% versus granulated sodium bentonite alone.

### Test 2—The Bulk Density Test

The bulk density of the granulated sodium bentonite tested was 1.1 g/cc. The bulk density of the particulated CCS was 0.0135 g/cc. The bulk density of the 5/95 w/w % mixture was measured as 0.82 g/cc, or a 25 wt. % reduction in bulk density with the addition of 5 wt. % CCS.

### Test 3—The Clumping Test

Combinations of sodium bentonite and CCS were made by mixing the two together. Water was added using a dropper and the mixture was observed to see if a clump formed. If a clump formed it was lifted and examined to see if it held together and could be removed. The sodium bentonite was granulated to about 12 screen (1.6 mm). The CCS was cut into 1 mm³ particles from CCS about 1 mm thick. The expansion ratio of the CCS was 5:1. For clumping, the optimum amount of CCS in the mixture was about 5 wt. % or less. Greater than about 5 wt. % caused the clumps to fall apart from rapid expansion when wetted and clumps did not form. Less than about 1 wt. % CCS caused the clumps to never form at all. The preferred amount of CCS was about 5 wt. %.

### Test 4—the Non-Segregation of Particles Test

A mixture of sodium bentonite and CCS was made. The sodium bentonite was granulated to about 12 screen (1.6 mm). Different sized CCS particles were prepared. When cut in rectangular shapes, the particles segregated from the sodium bentonite. When particles larger than about 1 mm³ were measured, the particles segregated from the sodium bentonite. When the CCS was cut into cubic 1 mm³ particles from CCS sheets about 1 mm thick, the particles did not segregate from the sodium bentonite. The closer the CCS particles are the size of the granulated sodium bentonite, the less likely they are to segregate.

The non-segregation is critical to the absorptivity and the clumping of the mixture. The sodium bentonite granules must be in contact with the CCS particles to clump when liquid is added.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An animal litter comprising sodium bentonite granules and particulated compressed cellulose sponge.

2. The animal litter of claim 1, wherein the compressed cellulose sponge is not treated with clumping agents, gelling agents or wetting agents; and
wherein the compressed cellulose sponge is not agglomerated with other components.

3. The animal litter of claim 2, wherein the compressed cellulose sponge particles are present in the litter from about 1 to 10 wt. %, and the sodium bentonite granules are present from about 99 to 90 wt. %.

4. The animal litter of claim 3, wherein the compressed cellulose sponge are cut in an approximate cubic shape with a length by width by depth dimension of from 10 mm³ to 0.1 mm³.

5. The animal litter of claim 4, wherein the sodium bentonite is granulated in the range of from 10 to 15 screen mesh.

6. The animal litter of claim 5, wherein the bulk density of the animal litter is less than about 1 g/cc.

7. The animal litter of claim 6, wherein the expansion ratio of the particulated compressed cellulose is from about 10:1 to 5:1.

8. The animal litter of claim 7, wherein the volume ratio of particulated compressed cellulose sponge to granulated sodium bentonite is in the range of from 50:50 v/v to 10:90 v/v.

9. The animal litter of claim 8, wherein the particulated compressed cellulose has a density of from 0.1 to 0.5 gm/cc.

10. The animal litter of claim 9, wherein the animal litter provides at least a 200% increase in aqueous absorptivity over that of granulated sodium bentonite alone.

11. An animal litter comprising sodium bentonite granules and particulated compressed cellulose sponge;
wherein the compressed cellulose sponge is not treated with clumping agents, gelling agents or wetting agents;
wherein before used as animal litter, the compressed cellulose sponge is not agglomerated with other components; and
wherein the compressed cellulose sponge is formed from dry cellulose sponge which is compressed under high pressure and heat to form the compressed cellulose sponge.

12. The animal litter of claim 11, wherein the dry cellulose sponge is made by mixing rigid cellulose with softeners to create a jelly-like slurry;
wherein sodium sulfate crystals are added to the mixture; wherein the cellulose mixture is heated; and
wherein the sodium sulfate crystals melt to form pores in the dry cellulose sponge.

13. The animal litter of claim 12, wherein the compressed cellulose sponge particles are present in the litter from about 1 to 10 wt. %, and the sodium bentonite granules are present from about 99 to 90 wt. %; and
wherein the compressed cellulose sponge are cut in an approximate cubic shape with a length by width by depth dimension of from 10 mm³ to 0.1 mm³.

14. The animal litter of claim 13, wherein the sodium bentonite is granulated in the range of from 10 to 15 screen mesh; and
wherein the bulk density of the animal litter is less than about 1 g/cc.

15. The animal litter of claim 14, wherein the expansion ratio of the particulated compressed cellulose is from about 10:1 to 5:1; and
wherein the volume ratio of particulated compressed cellulose sponge to granulated sodium bentonite is in the range of from 50:50 v/v to 10:90 v/v.

16. The animal litter of claim 15, wherein the particulated compressed cellulose has a density of from 0.1 to 0.5 gm/cc; and
wherein the animal litter provides at least a 200% increase in aqueous absorptivity over that of granulated sodium bentonite alone.

17. An animal litter comprising sodium bentonite granules and particulated compressed cellulose sponge,
wherein the compressed cellulose sponge particles are present in the litter from about 1 to 10 wt. %, and the sodium bentonite granules are present from about 99 to 90 wt. %;
wherein the compressed cellulose sponge are cut in an approximate cubic shape with a length by width by depth dimension of from 10 mm³ to 0.1 mm³; and
wherein the sodium bentonite is granulated in the range of from 10 to 15 screen mesh.

18. The animal litter of claim 17, wherein the bulk density of the animal litter is less than about 1 g/cc;
wherein the expansion ratio of the particulated compressed cellulose is from about 10:1 to 5:1;
wherein the volume ratio of particulated compressed cellulose sponge to granulated sodium bentonite is in the range of from 50:50 v/v to 10:90 v/v; and
wherein the particulated compressed cellulose has a density of from 0.1 to 0.5 gm/cc.

19. The animal litter of claim 18, wherein the animal litter provides at least a 200% increase in aqueous absorptivity over that of granulated sodium bentonite alone.

20. The animal litter of claim 19, wherein the compressed cellulose sponge is not treated with clumping agents, gelling agents or wetting agents; and
wherein before used as animal litter, the compressed cellulose sponge is not agglomerated with other components.
